(19) United States
(12) Patent Application Publication
(10) Pub. No.: US 2025/0337147 A1
(43) Pub. Date: Oct. 30, 2025

(54) Power Distributor/Combiner

(71) Applicant: TOKYO KEIKI INC., Tokyo (JP)

(72) Inventors: Motomu MATSUNAGA, Tokyo (JP); Hajime TAMURA, Tokyo (JP)

(21) Appl. No.: 18/681,901

(22) PCT Filed: Mar. 25, 2022
(86) PCT No.: PCT/JP2022/014316

§ 371 Date: Sep. 9, 2024

(30) Foreign Application Priority Data
Aug. 30, 2021 (JP) 2021-140072

(51) Int. Cl. H01P 5/16

(52) U.S. Cl. CPC H01P 5/16

(57) ABSTRACT

Provided is a power distributor/combiner 1 that outputs an input microwave power after distributed or combined; the power distributor/combiner 1 including: a main body 10 that defines a radial waveguide 101 as a substantially cylindrical cavity; a center terminal 11 as an electromagnetic field coupling terminal, arranged in the radial waveguide 101 of the main body 10 while aligned with the center axis C of the radial waveguide 101; and a plurality of peripheral terminals 12 as electromagnetic field coupling terminals, arranged in the radial waveguide 101 radially away from the center terminal 11, and the radial waveguide 101 having a radius R smaller than a quotient of a free-space wavelength at a frequency of the microwave power, divided by 2.619.

### TECHNICAL FIELD

Embodiments of this invention relate to a technology for distributing or combining microwave power.

### BACKGROUND ART

A cylindrical power distributor/combiner that uses a radial waveguide, formed in the shape of a hollow cylinder, has been known as a power distributor/combiner for distributing or combining microwave power. In the cylindrical power distributor/combiner, the radius R of its cylindrical cavity is determined on the basis of TM₀ₙ₀ (n: 1, 2, 3, . . . integer) mode, assuming the cavity as a circular cavity resonator. When operated in the TM₀₁₀ mode, the minimum radius Rₘᵢₙ of the cavity is given by an equation Rₘᵢₙ=λ/2.619, where λ represents a free-space wavelength at an operating frequency.

Such determination of the minimum radius Rₘᵢₙ on the basis of the operating frequency stands on a thought that electromagnetic wave, having a frequency equal to or smaller than the TM₀₁ mode cutoff frequency of the radial waveguide according to the TM₀₁₀ mode, is prevented from transmitting due to boundary conditions, which is supported by the fact that the resonant frequency of the cavity resonator coincides with the cutoff frequency of the radial waveguide having the same radius. The known cylindrical power distributor/combiner has therefore been structured to satisfy R≥λ/2.619.

There is a known related technology regarding a microwave power distributor/combiner structured to input (or output) a signal through a first coaxial terminal, and to output (or input) microwave signals through a plurality of second coaxial terminals, wherein the microwave power distributor/combiner includes a radial waveguide that serves as a transmission path between the first coaxial terminal and the second coaxial terminals, formed in the shape of thin cylindrical cavity; the first coaxial terminal being attached to the center of the radial waveguide; the second coaxial terminals being attached to positions a predetermined radial distance away from the center; and each of the first and the second coaxial terminals having, attached to the top end of the center conductor thereof, a conical coaxial radial waveguide converter for impedance matching with the radial waveguide (see Patent Literature 1, for example).

### CITATION LIST

### Patent Document

[Patent Document 1] JP H03-234103 A

### SUMMARY OF THE INVENTION

### Technical Problem

The problem desired to be solved is to further downsize the power distributor/combiner.

This invention was aimed at solving the aforementioned problem, and an object of which is to provide a technology focused on further downsizing of the power distributor/combiner.

### Solution to Problem

Aimed at solving the aforementioned problem, a power distributor/combiner of this invention is a power distributor/combiner that outputs an input microwave power after distributed or combined; the power distributor/combiner includes: a main body that defines a radial waveguide as a substantially cylindrical cavity; a center terminal as an electromagnetic field coupling terminal, arranged in the radial waveguide of the main body while aligned with the center axis of the radial waveguide; and a plurality of peripheral terminals as electromagnetic field coupling terminals, arranged in the radial waveguide radially away from the center terminal, and the radial waveguide having a radius smaller than a quotient of a free-space wavelength at a frequency of the microwave power, divided by 2.619.

### Advantageous Effects of Invention

This invention can further downsize the power distributor/combiner.

### BRIEF DESCRIPTION OF DRAWINGS

FIG. 1 is a perspective view illustrating a structure of a power distributor/combiner according to an embodiment.

FIG. 2 is a cross-sectional view illustrating the structure of the power distributor/combiner according to the embodiment.

FIG. 3 is a bottom view illustrating the structure of the power distributor/combiner according to the embodiment.

FIG. 4 is a block diagram illustrating a schematic construction of a power distribution system.

FIG. 5 is a block diagram illustrating a schematic construction of a power combination system.

FIG. 6 is a perspective view illustrating a structure of a power distributor/combiner according to a first example.

FIG. 7 is a cross-sectional view illustrating the structure of the power distributor/combiner according to the first example.

FIG. 8 is a drawing illustrating reflection characteristic of the center terminal, and pass characteristic between the center terminal and the peripheral terminals, according to the first example.

FIG. 9 is a perspective view illustrating a structure of the power distributor/combiner according to a second example.

FIG. 10 is a cross-sectional view illustrating the structure of the power distributor/combiner according to the second example.

FIG. 11 is a drawing illustrating reflection characteristic of the center terminal, and pass characteristic between the center terminal and the peripheral terminals, according to the second example.

### DESCRIPTION OF EMBODIMENTS

Embodiments and examples of this invention will be explained below, referring to the attached drawings. In the description below, the bottom side of a power distributor/combiner, shaped in a substantially cylindrical form as a whole, will be defined to be the lower side, meanwhile the top side opposed to the bottom side will be defined to be the upper side.

### Embodiment

### (Structure of Power Distributor/Combiner)

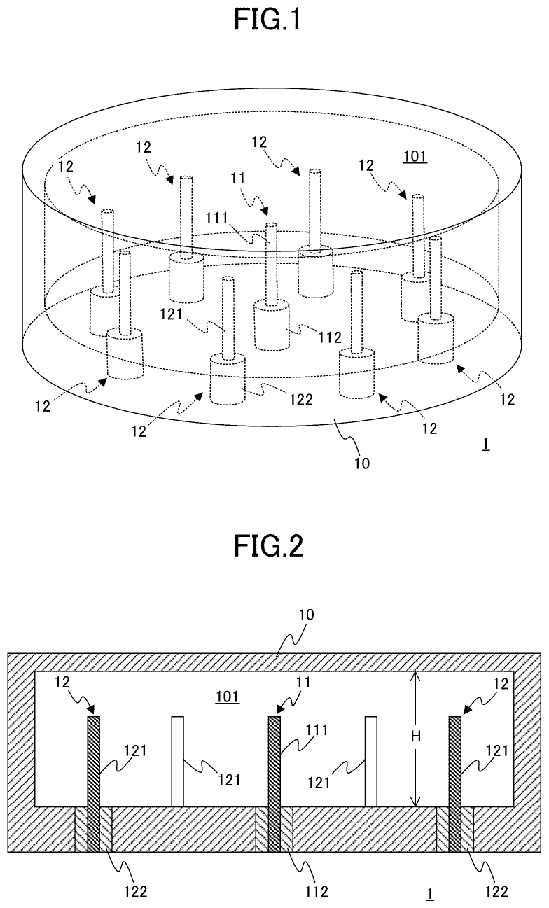

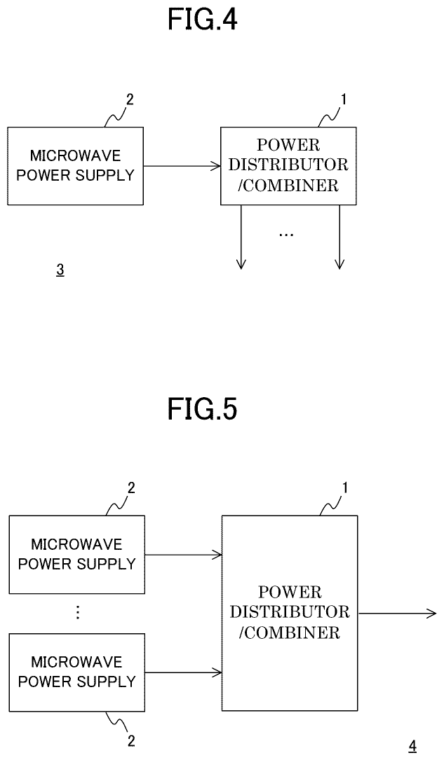

A power distributor/combiner according to this embodiment will be explained. FIGS. 1 to 3 are a perspective view, a cross-sectional view, and a bottom view, respectively, illustrating a structure of the power distributor/combiner according to this embodiment. FIG. 4 and FIG. 5 are block diagrams illustrating schematic constructions of a power distribution system and a power combination system, respectively.

As illustrated in FIGS. 1 to 3, a power distributor/combiner 1 according to this embodiment has a main body 10, one center terminal 11, and eight peripheral terminals 12. Note that FIG. 2 illustrates a cross-section of the power distributor/combiner, taken along a plane that extends vertically, lies in a radial direction of the near circular top face and the bottom face, and intersects the center terminal and two peripheral terminals that oppose in the radial direction.

The main body 10 is a metal container shaped as a whole in a near cylindrical form with the top and bottom openings closed, and has defined therein a radial waveguide 101 as a substantially cylindrical cavity. The center terminal 11 and the eight peripheral terminals 12 are provided on the circular bottom face of the main body 10. The center terminal 11 is arranged substantially at the center axis C of the radial waveguide 101. The eight peripheral terminals 12 are arranged on the bottom face of the main body 10 radially away from the center terminal 11, while regularly spaced in the circumferential direction. The power distributor/combiner 1 may only have at least two or more peripheral terminals 12.

The center terminal 11 has a center conductor 111 and a dielectric 112. Each of the plurality of peripheral terminals 12 has a center conductor 121 and a dielectric 122. Both of the center conductors 111, 121 are conductors shaped as a whole in a rod form, which is more specifically near cylindrical form. The dielectric 112 has inserted therein a part of the bottom end (lower side in FIG. 2) of the center conductor 111. Similarly, each dielectric 122 has inserted therein a part of the bottom end of each center conductor 121. Each of the center terminal 11 and the plurality of peripheral terminals 12, although structured in this embodiment as a monopole antenna, may only be structured as an electromagnetic field coupling terminal.

The center conductor 111 is provided to the main body 10 while supported by the dielectric 112, with the direction of extension thereof aligned to the vertical direction of the radial waveguide 101, with the axial center thereof substantially aligned with the center axis C of the radial waveguide 101, and with a part thereof not inserted in the dielectric 112 housed in the radial waveguide 101. Similarly, the center conductor 121 is provided to the main body 10 while supported by the dielectric 122, with the direction of extension thereof aligned to the vertical direction of the radial waveguide 101, and with a part thereof not inserted in the dielectric 122 housed in the radial waveguide 101.

The dielectrics 112, 122 are provided to the main body 10 as illustrated in FIG. 2, while individually fitted to holes that are formed in the bottom face of the main body 10. As a result of fitting of the dielectric 112 having the center conductor 111 inserted therein, and the dielectrics 122 having the center conductors 121 inserted therein, to the bottom face of the main body 10, the center conductors 111, 121 are individually supported by the main body 10, so as to be electrically connectable from the outside of the power distributor/combiner 1.

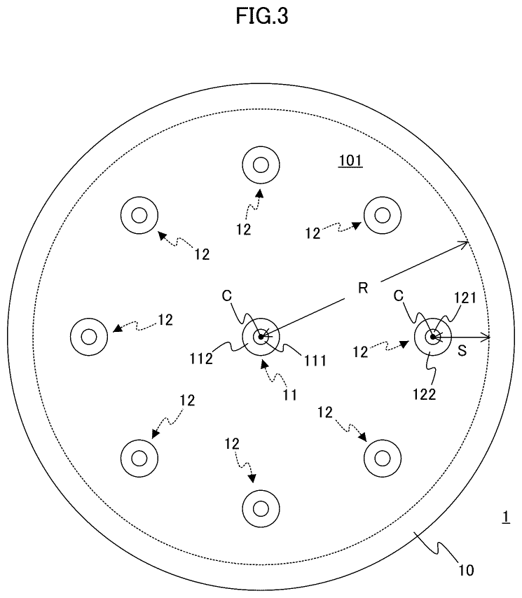

For the purpose of suppressing any higher mode from generating, the main body 10 is formed so that the height H (see FIG. 2) of the radial waveguide 101, which is the distance measured in the direction of center axis between the top face and the bottom face, will be equal to or shorter than a half of the free-space wavelength at an operating frequency. Now, the operating frequency is a frequency of the microwave power input to the power distributor/combiner 1. The main body 10 is also formed so that the radius R of the radial waveguide 101 (see FIG. 3) will be smaller than λ/2.619, where λ is a free-space wavelength at operating frequency. The radius R herein is a radial distance measured from the center axis of the radial waveguide 101, which is a space defined as a substantially cylindrical cavity, to the inner wall of the main body 10.

Relation between the radius of the internal cavity of the cylindrical metal container and TM₀₁ mode magnetic field has been analytically determined, teaching that electromagnetic wave sharply attenuates in the cylindrical metal container whose internal cavity has a radius of λ/2.619 or smaller. According to the knowledge, prior power distributors/combiners with radial waveguides have been formed to have a radius R of the radial waveguide of λ/2.619 or larger. Our simulation has, however, revealed that the radial waveguide having a plurality of terminals arranged therein can occasionally satisfy the boundary conditions of the cylinder wall with respect to an electric wave having a frequency lower than the cutoff frequency, even if the radius of the radial waveguide is smaller than λ/2.619, and can distribute/combine microwave power.

In a case where the center terminal 11 and the plurality of peripheral terminals 12 are structured to be monopole antennas, each of the peripheral terminals 12 is arranged so that a separation distance S, which is a shortest distance measured between the center axis of the center conductor 121 of the peripheral terminal 12 and the inner wall of the main body 10, is equal to or shorter than ⅛ of the free-space wavelength at the operating frequency. The separation distance S will be detailed later.

The thus structured power distributor/combiner 1 may be down-sized than before, by shortening the radius R, and as well as the separation distance S, thus making it possible to downsize a power distribution system 3 illustrated in FIG. 4, and a power combination system 4 illustrated in FIG. 5.

As illustrated in FIG. 4, the power distribution system 3 has the power distributor/combiner 1 and a microwave power supply 2. The power distributor/combiner 1 in the power distribution system 3 functions as a power distributor that distributes microwave power having been input through the center terminal 11 from the microwave power supply 2, and outputs the distributed power through the plurality of peripheral terminals 12.

As illustrated in FIG. 5, the power combination system 4 has the power distributor/combiner 1, and at least two microwave power supplies 2. The power distributor/combiner 1 in the power combination system 4 functions as a power combiner that combines microwave power, having been input from each of the plurality of microwave power supplies 2 through the plurality of peripheral terminals 12, and outputs the combined power through the center terminal 11.

### (Operations of Power Distributor/Combiner)

Operations of the power distributor/combiner, and the separation distance between the peripheral terminals and the inner wall will be explained.

In a case where the power distributor/combiner 1 is allowed to function as a power distributor in response to input of microwave power through the center terminal 11 structured as a monopole antenna, microwave will be radiated concentrically from the center terminal 11 within the radial waveguide 101. A part of the thus radiated microwave is captured by the plurality of peripheral terminals 12 structured as the monopole antennas, and the distributed microwave powers, all in the same phase and same amplitude, are output through the plurality of peripheral terminals 12.

A part of the microwave not captured by the peripheral terminals 12 is reflected on the inner wall of the main body 10. Hence, it has been a conventional idea to constitute the power distributor/combiner 1 without causing transmission mismatching of the microwave from the center terminal 11 to the peripheral terminals 12, by properly adjusting the separation distance S over which the reflected wave and the direct wave are mutually cancelled. It has widely been believed that the separation distance S is preferably adjusted to ¼ of the free-space wavelength of the operating frequency, so as to make the reflected wave and the direct wave will have the same phase at the position of the peripheral terminals 12.

This explanation, only considering the microwave that is directly directed from the center terminal to the peripheral terminals 12, does not however fully describe the reflection of microwave, since the microwave can be reflected everywhere within the radial waveguide 101. Our simulation revealed that the power distributor/combiner 1 can function as a power distributor without causing mismatching, even if the separation distance S was adjusted to ⅛ or shorter of the free-space wavelength at the operating frequency. Also the power distributor/combiner 1, when used as a power combiner, can operate without causing mismatching, according to the reversibility principle.

### First Example

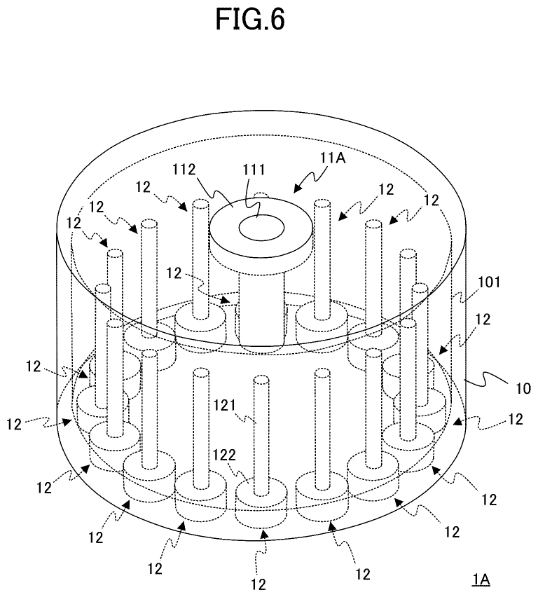

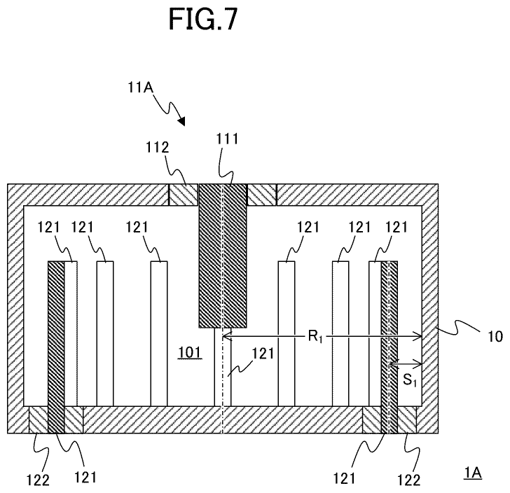

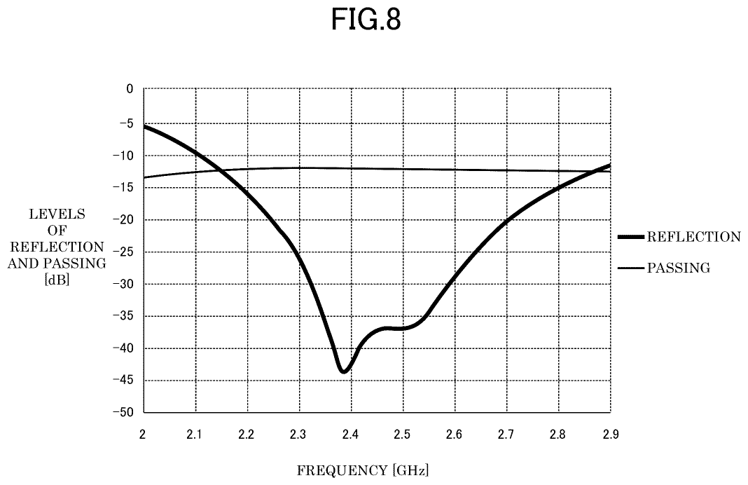

A power distributor/combiner according to a first example will be explained. FIG. 6 and FIG. 7 are a perspective view and a cross-sectional view, respectively, of a power distributor/combiner according to this example. FIG. 8 is a drawing illustrating reflection characteristic of the center terminal, and pass characteristic between the center terminal and the peripheral terminals, according to this example. Note that FIG. 7 illustrates a cross section of the power distributor/combiner taken along a plane same as that in FIG. 2.

As illustrated in FIG. 6 and FIG. 7, a power distributor/combiner 1A according to this example is a 16-way distributor/combiner adapted to 2.45 GHz band, and is different from the power distributor/combiner 1 in that a center terminal 11A is provided to the top face of the main body 10, and in that sixteen peripheral terminals 12 are provided. Each of the center terminal 11A and the sixteen peripheral terminals 12 is structured as a monopole antenna. Assuming the cutoff frequency be 2.45 GHz, the free-space wavelength divided by 2.619 will give a quotient represented by 300/2.45/2.618˜46.8 [mm].

As illustrated in FIG. 7, the power distributor/combiner 1A has a radius R₁ of 36.7 mm, meanwhile a separation distance S₁ is 6 mm, which is shorter than 1/20 of the free-space wavelength. Simulation of an electromagnetic field of such power distributor/combiner 1A gave the reflection characteristic and the pass characteristic illustrated in FIG. 8. These results prove sufficient feasibility of the power distributor/combiner 1A, if downsized from the prior power distributor/combiner.

### Second Example

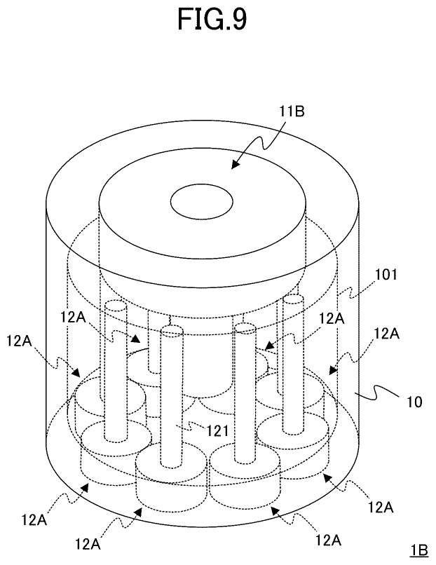

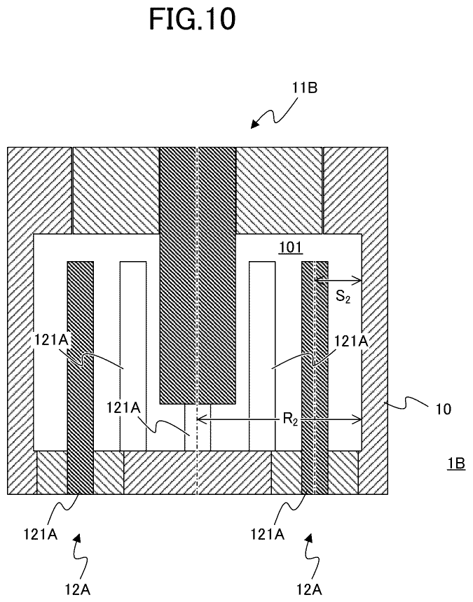

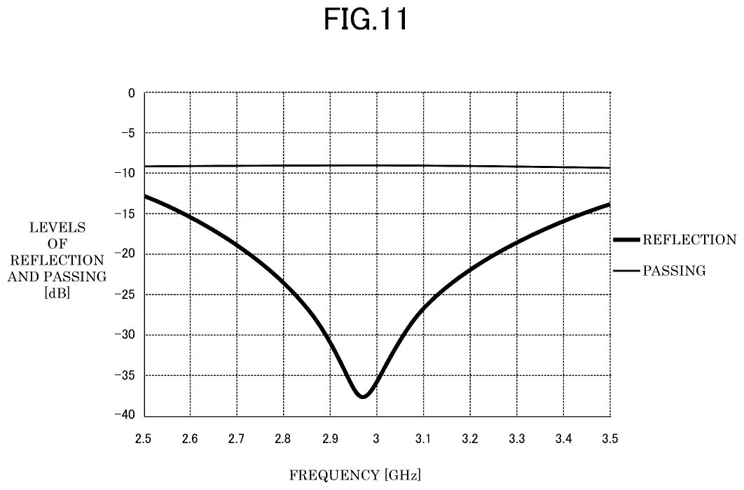

A power distributor/combiner according to a second example will be explained. FIG. 9 and FIG. 10 are a perspective view and a cross-sectional view, respectively, of a power distributor/combiner according to this example. FIG. 11 is a drawing illustrating reflection characteristic of the center terminal, and pass characteristic between the center terminal and the peripheral terminals, according to this example. Note that FIG. 10 illustrates a cross section of the power distributor/combiner taken along a plane same as that in FIG. 2 or FIG. 7.

As illustrated in FIG. 9 and FIG. 10, a power distributor/combiner 1B according to this example is an 8-way distributor/combiner adapted to 3 GHz band, and is different from the power distributor/combiner 1 in that a center terminal 11B is provided to the top face of the main body 10, and in that eight peripheral terminals 12A are provided. The center terminal 11B is structured as a monopole antenna whose center conductor of a 20D coaxial tube is extended within the radial waveguide 101. Each of the eight peripheral terminals 12A is structured as a monopole antenna whose center conductor 121A of an N-type connector is extended within the radial waveguide 101. Assuming the cutoff frequency be 3 GHz, the free-space wavelength divided by 2.619 will give a quotient represented by 300/3/2.619˜38.2 [mm].

As illustrated in FIG. 10, the power distributor/combiner 1B has a radius R₂ of 18.9 mm, which is shorter than a half of 38.1 mm, meanwhile a separation distance S₂ is 5.4 mm, which is shorter than 1/18 of the free-space wavelength. Simulation of an electromagnetic field of such power distributor/combiner 1B gave the reflection characteristic and the pass characteristic illustrated in FIG. 11. These results prove sufficient feasibility of the power distributor/combiner 1B, if downsized from the prior power distributor/combiner.

The embodiments of this invention are merely exemplary ones, and are not intended to limit the scope of the invention. These novel embodiments may be implemented in other various ways, and may be partially omitted, replaced or modified without departing from the spirit of the invention. Also these embodiments and modifications thereof fall within the scope and essence of this invention, and also fall within the inventions described in claims and the equivalents.

### REFERENCE SIGNS LIST

1 power distributor/combiner
10 main body
11 center terminal
12 peripheral terminal
101 radial waveguide

1. A power distributor/combiner that outputs an input microwave power after distributed or combined; the power distributor/combiner comprising:
a main body that defines a radial waveguide as a substantially cylindrical cavity;
a center terminal as an electromagnetic field coupling terminal, arranged in the radial waveguide of the main body while aligned with the center axis of the radial waveguide; and
a plurality of peripheral terminals as electromagnetic field coupling terminals, arranged in the radial waveguide radially away from the center terminal, and
the radial waveguide having a radius smaller than a quotient of a free-space wavelength at a frequency of the microwave power, divided by 2.619.

2. The power distributor/combiner according to claim 1, wherein each of the plurality of peripheral terminals is structured as a monopole antenna having a conductor that extends in the direction of center axis of the radial waveguide, and
each of the peripheral terminals keeps the minimum distance between an axial center of the conductor and an inner wall of the main body, which measures ⅛ or smaller of the free-space wavelength at a frequency of the microwave power.
